(19) United States
(12) Patent Application Publication
(10) Pub. No.: US 2021/0198146 A1
(43) Pub. Date: Jul. 1, 2021

(54) WHOLE-GRANULATION STEEL SLAG PAVEMENT BASE COURSE MATERIAL FOR HEAVY-LOAD PAVEMENT

(71) Applicant: WUHAN UNIVERSITY OF TECHNOLOGY, Hubei (CN)

(72) Inventors: Meizhu Chen, HUBEI (CN); Xuanwen Gou, HUBEI (CN); Dengfeng Zhang, HUBEI (CN); Shaopeng Wu, HUBEI (CN); Jun Xie, HUBEI (CN); Quantao Liu, HUBEI (CN); Dezhi Kong, HUBEI (CN); Hechuan Li, HUBEI (CN); Zhifeng Xiao, HUBEI (CN); Yanfei Ren, HUBEI (CN); Qi Jiang, HUBEI (CN)

(73) Assignee: WUHAN UNIVERSITY OF TECHNOLOGY, HUBEI (CN)

(21) Appl. No.: 17/002,763

(22) Filed: Aug. 25, 2020

(30) Foreign Application Priority Data
Dec. 31, 2019 (CN) 201911412263.2

(51) Int. Cl. C04B 28/08

(52) U.S. Cl. CPC C04B 28/082; C04B 2111/0075

(57) ABSTRACT

The invention provides a whole-granulation steel slag pavement base course material for a heavy-load pavement, which is prepared by uniformly mixing dry materials with water. The dry materials include a binder and a steel slag aggregate. The percentages in total mass of the binder and the steel slag aggregate are as follows: the binder is 3.4% to 5.0%, and the steel slag aggregate is 95.0% to 96.6%. The binder is prepared by mixing cement with steel slag micropowder according to a certain proportion, wherein the mass percentages of the cement and the steel slag micropowder are as follows: the cement is 70% to 90%, and the steel slag micropowder is 10% to 30%. The water accounts for 5% to 6% of the total mass of the dry materials.

### CROSS-REFERENCE TO RELATED APPLICATION

This application claims the priority benefit of China application serial no. 201911412263.2, filed on Dec. 31, 2019. The entirety of the above-mentioned patent application is hereby incorporated by reference herein and made a part of this specification.

### TECHNICAL FIELD

The present invention relates to the technical field of building materials, and more particularly relates to a whole-granulation steel slag pavement base course material for a heavy-load pavement.

### BACKGROUND

In an asphalt pavement structure, a base course mainly bears a road load and transmits a force to a road bed uniformly. A surface course mainly plays the roles of skid resistance, wear resistance, water tightness, and driving safety. A survey shows that many pavements in our country are currently in a heavy-load traffic environment, and serious early damage phenomena will often occur in such pavements soon. These damages are closely related to the performance of base course materials. A heavy-load pavement has a high traffic volume and a heavy load, and thus has higher requirements on the strength and the dry shrinkage of the base course materials. In addition, both the surface course and the base course of the pavement consume a large number of stones, and most of aggregates currently used in China are non-renewable natural aggregates. The collection of these aggregates will destroy the ecological environment to be not in line with the strategic guideline of sustainable development of China, so that seeking alternatives of the natural aggregates is of great practical significance for our economic development and environmental protection.

Steel slag is molten slag discharged during steel making, which is a main solid by-product of the smelting industry, and the output is very large. If a large amount of steel slag is not handled scientifically, it will bring many adverse effects as follows: first, the accumulation of the steel slag will occupy lots of lands to affect the effective use of the lands; and second, the steel slag contains a certain amount of harmful heavy metal elements, so that long-term open storage will cause water and soil pollution. A large number of studies have shown that the steel slag has excellent mechanical properties as follows: the steel slag has higher specific gravity than the natural aggregates, is hard and wear resistant, has a surface generally having a porous structure and rich texture, usually has a higher specific surface area and a water absorption rate higher than that of the natural aggregates and is good in angularity. Granulated slag with different particle sizes produced after treatment has the potential of being used as high-quality aggregates. Main mineral components of converter steel slag include: C₂S, C₂F, Fe₁₋ₓO, C₄AF, CaO, Ca(OH)₂ and CaCO₃. The existence of C₂S, C₂F and C₄AF makes the steel slag have a potential cementitious activity, which has great advantages compared with the natural aggregates.

By the use of excellent physical and chemical properties of the steel slag, the steel slag is applied to the base course materials to prepare a steel slag pavement base course material. When used for a heavy-load pavement, the steel slag pavement base course material can prolong the service life of the heavy-load pavement and increase a utilization rate of the steel slag. A Chinese patent CN105948639A discloses “a high-strength low-shrinkage crack-resistant pavement base course material”, the base course material is prepared from cement, steel slag sand, fine-grained soil, an admixture system and water, and although the base course material with higher strength and lower dry shrinkage is obtained, the utilization rate of the steel slag is lower, and an admixture with more complex components is used. A Chinese patent CN102491703A discloses “a steel slag water-stabilized base course material”, the water-stabilized base course material is prepared from cement, steel slag aggregates, an additive system and water, although the steel slag is used in the aggregates, a relatively large amount of cement is used, which is 4% to 6%, and the use of a retarder and crack inhibitor admixture increases the cost, and moreover, the particle size range of the steel slag used is also small, which is 0.5 mm to 20 mm, and no steel slag micropowder is used.

### SUMMARY

Based on the above disadvantages of the prior art, the technical problem to be solved by the present invention is to provide a whole-granulation steel slag pavement base course material for a heavy-load pavement. Thermally disintegrated steel slag satisfying the steel slag requirements in the standard Technical Specification for Construction of Steel Slag Mixture Used As Base Course YB/T 4184-2009 is selected as an aggregate of a semi-rigid base course, and a cement-steel slag micropowder compound binder is used in the base course material to fully exert the physical and chemical properties of the steel slag to prepare a road base course material with high strength and low dry shrinkage, and the road base course material is applicable to the heavy-load pavement.

In order to solve the above technical problem, the present invention provides a whole-granulation steel slag pavement base course material for a heavy-load pavement, which is prepared by uniformly mixing dry materials with water. The dry materials include a binder and a steel slag aggregate, and the percentages in total mass of the binder and the steel slag aggregate are as follows: the binder is 3.4% to 5.0%, and the steel slag aggregate is 95.0% to 96.6%. The binder is prepared by mixing cement with steel slag micropowder according to a certain proportion, and the mass percentages of the cement and the steel slag micropowder are as follows: the cement is 70% to 90%, and the steel slag micropowder is 10% to 30%. The water accounts for 5% to 6% of the total mass of the dry materials.

As a preference of the above technical solution, the whole-granulation steel slag pavement base course material for the heavy-load pavement further includes part or all of the following technical features.

As an improvement of the above technical solution, the cement in the binder is P.C 32.5 composite Portland cement.

As an improvement of the above technical solution, the steel slag micropowder in the binder is finely ground converter steel slag powder with certain cementitious activity, and has a specific surface area not less than 400 m²/kg, a passing rate is 90% or above in sieve pores with a pore size of 0.075 mm, and the content of free calcium oxide (f-CaO) does not exceed 3.0 wt %.

As an improvement of the above technical solution, the steel slag aggregate in the dry materials is thermally disintegrated steel slag obtained by smashing waste slag discharged from a steel mill and performing magnetic separation according to a thermal disintegrating method, and has an apparent density not less than 3.2 g/cm³; the steel slag is divided into a coarse steel slag aggregate and a fine steel slag aggregate according to sieve pores of 4.75 mm; and the steel slag has grades of: 15 wt % to 18 wt % for a pore size of 19 mm to 26.5 mm, 20 wt % to 24 wt % for a pore size of 9.5 mm to 19 mm, 19 wt % to 21 wt % for a pore size of 4.75 mm to 9.5 mm, 13 wt % to 15 wt % for a pore size of 2.36 mm to 4.75 mm, and 23 wt % to 27 wt % for a pore size of 0 mm to 2.36 mm.

As an improvement of the above technical solution, immersion expansion ratios of the course steel slag aggregate and the fine steel slag aggregate do not exceed 2.0%.

As an improvement of the above technical solution, the content of f-CaO in the steel slag aggregate does not exceed 3.0 wt %.

As an improvement of the above technical solution, the content of the f-CaO is measured according to a glycerol-ethanol method.

As an improvement of the above technical solution, the water is ordinary drinking water.

The whole-granulation steel slag pavement base course material for the heavy-load pavement is prepared by a method through the following steps:

step 1: respectively selecting a binder and a steel slag aggregate according to the requirements that: the percentages in total mass of the binder and the steel slag aggregate are as follows: the binder is 3.4% to 5.0%, and the steel slag aggregate is 95.0% to 96.6%; the binder is prepared by mixing cement with steel slag micropowder according to a certain proportion; the mass percentages of the cement and the steel slag micropowder are as follows: the cement is 70% to 90%, and the steel slag micropowder is 10% to 30%; the steel slag aggregate has grades of: 15 wt % to 18 wt % for a pore size of 19 mm to 26.5 mm, 20 wt % to 24 wt % for a pore size of 9.5 mm to 19 mm, 19 wt % to 21 wt % for a pore size of 4.75 mm to 9.5 mm, 13 wt % to 15 wt % for a pore size of 2.36 mm to 4.75 mm, and 23 wt % to 27 wt % for a pore size of 0 mm to 2.36 mm;
step 2: placing the steel slag aggregate in an environment at 105° C.±5° C., and drying the aggregate for generally not shorter than 4 hour to 6 hour until a constant weight is achieved;
step 3: taking 5 parts of the dry materials according to a mass ratio, setting 5 groups of water contents in advance, with a difference of 0.5% to 1.5% in sequence, then adding water into the dry materials respectively to obtain a mixture, stirring the mixture until the mixture is uniform, performing heavy compaction, testing an actual water content and a maximum dry density, and finally drawing a dry density curve to obtain an optimal water content and a maximum dry density, wherein a test method for the heavy compaction refers to a method T0804-1994 in the standard Test Methods of Materials Stabilized with Inorganic Binders for Highway Engineering JTG E51-2009;
step 4: taking an appropriate amount of the dry materials according to a certain mass ratio, adding water required for immersion, then mixing the dry materials with the water to obtain a mixture, stirring the mixture for 5 minute to 10 minute until the mixture is uniform, and putting the uniformly mixed mixture into a closed container for immersion for 6 hour to 12 hour, wherein the content of the added water is 1% to 2% less than the optimal water content in the step 3;
step 5: adding an appropriate amount of water into the immersed material in the step 4 to reach the optimal water content, stirring the water and the mixture for 5 minute to 10 minute, then adding an uniformly mixed binder to obtain a mixture, and performing secondary stirring for 5 minute to 10 minute until the mixture is uniformly mixed; and
step 6: within 1 hour after adding the binder, uniformly filling a mold with the stirred mixture, controlling the density, and performing static press molding to obtain a base course material test sample, wherein a molding process is carried out in accordance with a method T0843-2009 in the standard Test Methods of Materials Stabilized with Inorganic Binders for Highway Engineering JTG E51-2009.

The principle of the present invention is as follows.

1. The doping of the steel slag micropowder has a micro-aggregate effect, which can improve the grade of the aggregate; the surface of the steel slag aggregate has a large number of micropores, and the aggregate is good in angularity, so that the cement particles are better in binding property with the steel slag aggregate, and the steel slag has potential cementitious activity, so that as time flies, the activity of the steel slag is activated. Under the common action of the three factors, the steel slag aggregate, the steel slag micropowder and the cement form a compact material system to obtain the steel slag base course material with relatively high strength.
2. The steel slag has expansibility, so that the slight expansion property of the steel slag base course is used to compensate the dry shrinkage to reduce the dry shrinkage amount of the base course material.

Compared with the prior art, the technical solution of the present invention has the following beneficial effects:

1. by the use of the excellent physical properties and the potential cementitious activity of the steel slag, the base course material with high strength, small use amount of cement and low dry shrinkage is prepared without admixtures, and is applicable to the heavy-load pavement to prolong the service life of the heavy-load pavement; and
2. the application of the whole-granulation steel slag in the base course material is realized, natural resources are effectively saved, the problems such as environmental pollution caused by improper steel slag treatment are alleviated, the production cost is reduced, and outstanding social, economical and environmental benefits are achieved.

The above description is only a summary of the technical solution of the present invention. To learn the technical measures of the present invention more clearly, the technical solutions can be implemented in accordance with the content of the specification, and to make the above and other objectives, features and advantages of the present invention more understandable, the present invention is described in detail below in combination with preferable examples.

### BRIEF DESCRIPTION OF THE DRAWINGS

In order to describe the technical solutions of the examples of the present invention more clearly, accompanying drawings of the examples are briefly described below.

FIG. 1 is an unconfined compressive strength diagram of a base course material of each preferable example of the present invention; and

FIG. 2 is a test result diagram of a 60d total dry shrinkage coefficient of a base course material of each preferable example of the present invention.

### DETAILED DESCRIPTION

The following is a detailed description of specific implementation modes of the present invention. As a part of the specification, the principle of the invention is described through examples, and other aspects, features, and advantages of the present invention will become clear from this detailed description.

In the following examples, a specific surface area of steel slag micropowder used is 450 m²/kg, a passing rate is 91% in sieve pores with a pore size of 0.075 mm, and the content of free calcium oxide (f-CaO) is 2.1 wt %.

In the following examples, the steel slag aggregate used is thermally disintegrated steel slag, and the aging time is 12 months or longer. The apparent relative density is 3.6 to 3.7 g/cm³, and a crushing value is 12.1%. The steel slag is divided into a coarse steel slag aggregate and a fine steel slag aggregate according to sieve pores of 4.75 mm. The content of f-CaO in the fine steel slag aggregate is 1.12 wt %, and the content of CaO in the course steel slag aggregate is 1.51 wt %.

In the following examples, the water used is ordinary drinking water.

### Example 1

According to a whole-granulation steel slag pavement base course material for a heavy-load pavement, the percentages in total mass of a binder and a steel slag aggregate in dry materials are as follows: the binder is 4.8%, and a course steel slag aggregate is 95.2%. The binder is prepared by mixing cement with steel slag micropowder, and a mass ratio of the cement to the steel slag micropowder is 9:1. The steel slag has grades of: 17 wt % for a pore size of 19 mm to 26.5 mm, 23 wt % for a pore size of 9.5 mm to 19 mm, 20 wt % for a pore size of 4.75 mm to 9.5 mm, 15 wt % for a pore size of 2.36 mm to 4.75 mm, and 25 wt % for a pore size of 0 mm to 2.36 mm.

A preparation method of the above whole-granulation steel slag pavement base course material for the heavy-load pavement includes the following steps.

1) A steel slag aggregate and a binder are weighed according to the above mixing ratio, wherein synthesizing grades of the steel slag aggregate refer to Table 1.
2) The steel slag aggregate is placed in an environment at 105° C.±5° C., and the aggregate is dried (for generally not shorter than 4 hour to 6 hour) until a constant weight is achieved.
3) 5 parts of an appropriate amount of dry materials are taken according to the mass ratio, and water contents of 3%, 4%, 5%, 6% and 7% are set in advance; then, water is added into the dry materials respectively to obtain a mixture and the mixture is stirred until the mixture is uniform; and then, heavy compaction is performed, an actual water content and a maximum dry density are tested, and finally, a dry density curve is drawn to obtain an optimal water content. The optimal water content refers to Table 2.
4) An appropriate amount of the dry materials are taken according to a certain mass ratio; water required for immersion (the water content added at this time should be 1% to 2% less than the optimal water content in the step 3) is taken; the dry materials and the water are mixed to obtain a mixture and the mixture is stirred for 5 minute to 10 minute until the mixture is uniform; and the uniformly mixed mixture is put into a closed container for immersion for 6 hour to 12 hour.
5) An appropriate amount of water is added into the immersed mixture in the step 4 to reach the optimal water content, and the water and the mixture are stirred for 5 minute to 10 minute; and then, a uniformly mixed binder is added to obtain a mixture, and secondary stirring is performed for 5 minute to 10 minute until the mixture is uniformly stirred.
6) Within 1 hour after adding the binder, a mold is uniformly filled with the stirred mixture, the density is controlled, and static press molding is performed to obtain a base course material test sample.

### Example 2

According to a whole-granulation steel slag pavement base course material for a heavy-load pavement, the percentages in total mass of a binder, a natural aggregate and a steel slag aggregate in dry materials are as follows: the binder is 4.3%, and a course steel slag aggregate is 95.7%. The binder is prepared by mixing cement with steel slag micropowder, and a mass ratio of the cement to the steel slag micropowder is 7:3. The steel slag has grades of: 16 wt % for a pore size of 19 mm to 26.5 mm, 24 wt % for a pore size of 9.5 mm to 19 mm, 20 wt % for a pore size of 4.75 mm to 9.5 mm, 14 wt % for a pore size of 2.36 mm to 4.75 mm, and 26 wt % for a pore size of 0 mm to 2.36 mm.

A preparation method of the above whole-granulation steel slag pavement base course material for the heavy-load pavement is the same as the preparation method in Example 1.

### Example 3

According to a whole-granulation steel slag pavement base course material for a heavy-load pavement, the percentages in total mass of a binder, a natural aggregate and a steel slag aggregate in dry materials are as follows: the binder is 3.4%, and the steel slag aggregate is 96.6%. The binder is prepared by mixing cement with steel slag micropowder, and a mass ratio of the cement to the steel slag micropowder is 9:1. The steel slag has grades of: 16 wt % for a pore size of 19 mm to 26.5 mm, 24 wt % for a pore size of 9.5 mm to 19 mm, 20 wt % for a pore size of 4.75 mm to 9.5 mm, 15 wt % for a pore size of 2.36 mm to 4.75 mm, and 25 wt % for a pore size of 0 mm to 2.36 mm.

A preparation method of the above whole-granulation steel slag pavement base course material for the heavy-load pavement is the same as the preparation method in Example 1.

### Comparative Example

A pure natural aggregate pavement base course material is prepared by mixing straight cement and a natural aggregate in mass percentages of 4.7% and 95.3%. The natural aggregate has grades of: 18 wt % for a pore size of 19 mm to 26.5 mm, 24 wt % for a pore size of 9.5 mm to 19 mm, 20 wt % for a pore size of 4.75 mm to 9.5 mm, 12 wt % for a pore size of 2.36 mm to 4.75 mm, and 26 wt % for a pore size of 0 mm to 2.36 mm.

A preparation method of the above base course material of the comparative example is the same as the preparation method in Example 1.

TABLE 1
C-B-1 Screening and Synthesizing Grades
mass percentage (%) passing through sieve pores (mm) of a square pore sieve

| Sieve Pore | 26.5 | 19 | 16 | 13.2 | 9.5 | 4.75 | 2.36 | 1.18 | 0.6 | 0.3 | 0.15 | 0.075 |
|---|---|---|---|---|---|---|---|---|---|---|---|---|
| Example 1 | 100 | 84.4 | 77.0 | 68.9 | 58.1 | 37.6 | 26.4 | 16.0 | 12.0 | 8.1 | 5.2 | 2.9 |
| Example 2 | 100 | 85.2 | 76.7 | 69.6 | 58.1 | 39.9 | 25.8 | 17.8 | 13.4 | 8.1 | 5.4 | 2.9 |
| Example 3 | 100 | 85.2 | 76.7 | 69.6 | 58.1 | 39.9 | 25.2 | 17.2 | 12.9 | 7.8 | 5.2 | 2.8 |
| Comparative | 100 | 85.4 | 75.2 | 67.5 | 58.6 | 39.9 | 25.2 | 17.5 | 13.2 | 8.0 | 5.3 | 2.7 |
| Example | | | | | | | | | | | | |

TABLE 2
Optimal Water Content and Maximum Dry Density

| | Example | Example | Example | Comparative |
|---|---|---|---|---|
| Compaction Test | 1 | 2 | 3 | Example |
| Optimal Water | 5.7 | 5.5 | 5.8 | 5.1 |
| Content % | | | | |
| Maximum Dry Density | 2.885 | 2.856 | 2.833 | 2.312 |
| g/cm³ | | | | |

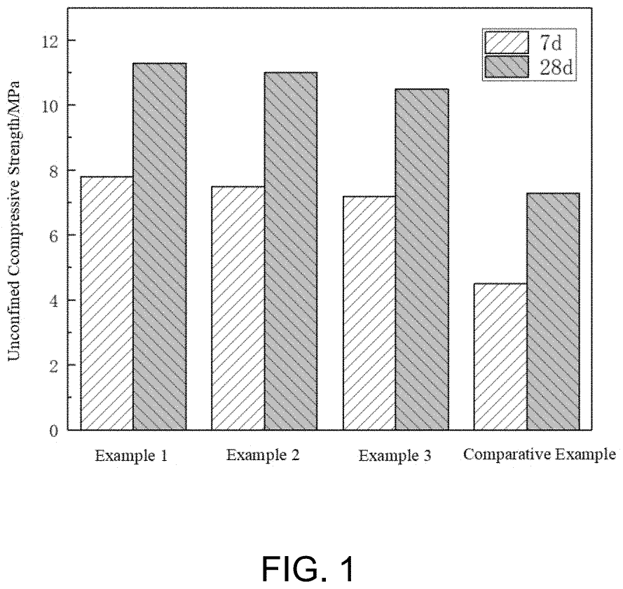

7d and 28d unconfined compressive strength tests are carried out on the base course materials of the three examples and the comparative example according to the requirements in the standard Test Methods of Materials Stabilized with Inorganic Binders for Highway Engineering (JTG/E51-2009), and test results are as shown in FIG. 1.

It can be seen from FIG. 1 that the 7d and 28d unconfined compressive strength of the three examples is much higher than that of the comparative example, which indicates that the steel slag aggregate base course material provided by the present invention is featured with high strength and is applicable to the heavy-load pavement.

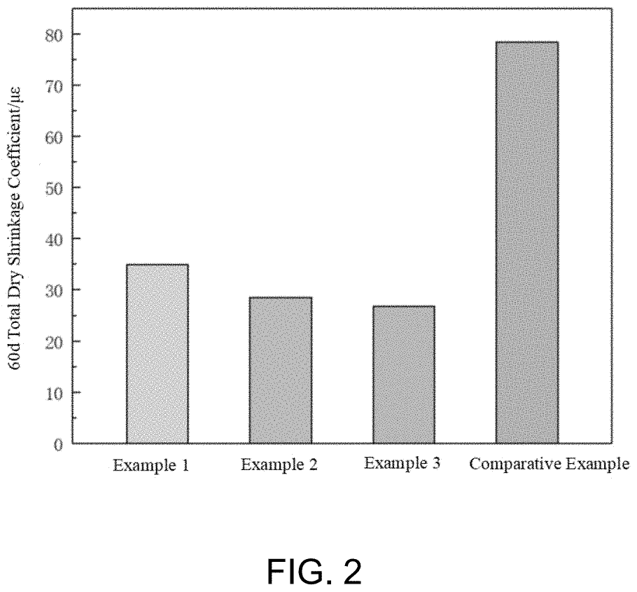

Dry shrinkage tests are carried out on the base course materials of the three examples and the comparative example according to the requirements in the standard Test Methods of Materials Stabilized with Inorganic Binders for Highway Engineering (JTG/E51-2009), and test results of 60d total dry shrinkage coefficients are as shown in FIG. 2.

It can be seen from FIG. 2 that the total dry shrinkage coefficients of the three examples are obviously lower than the total dry shrinkage coefficient of the comparative example, which indicates that the whole-granulation steel slag aggregate base course material provided by the present invention is featured with low dry shrinkage.

The various raw materials listed in the present invention, upper and lower limits and range values of the various raw materials of the present invention, and upper and lower limits and range values of process parameters (such as temperature and time) can all implement the present invention, and examples are not stated one by one herein.

The above is only the preferred implementation modes of the present invention, and of course, cannot be used to limit the claims of the present invention. It should be noted that those of ordinary skill in the art can further make several improvements and changes without departing from the principles of the present invention. These improvements and changes shall all fall within the protection scope of the present invention.

What is claimed is:

1. A whole-granulation steel slag pavement base course material for a heavy-load pavement, comprising: being prepared by uniformly mixing dry materials with water, the dry materials comprise a binder and a steel slag aggregate, wherein percentages in a total mass of the binder and the steel slag aggregate are as follows: the binder is 3.4% to 5.0%, and the steel slag aggregate is 95.0% to 96.6%; the binder is prepared by mixing cement with steel slag micropowder according to a certain proportion, mass percentages of the cement and the steel slag micropowder are as follows: the cement is 70% to 90%, and the steel slag micropowder is 10% to 30%, and the water accounts for 5% to 6% of a total mass of the dry materials.

2. The whole-granulation steel slag pavement base course material for the heavy-load pavement according to claim 1, wherein the cement in the binder is P.C 32.5 composite Portland cement.

3. The whole-granulation steel slag pavement base course material for the heavy-load pavement according to claim 1, wherein the steel slag micropowder in the binder is finely ground converter steel slag powder with certain cementitious activity, and has a specific surface area not less than 400 m²/kg, a passing rate is 90% or above in sieve pores with a pore size of 0.075 mm, and the content of free calcium oxide (f-CaO) does not exceed 3.0 wt %.

4. The whole-granulation steel slag pavement base course material for the heavy-load pavement according to claim 1, wherein the steel slag aggregate in the dry materials is thermally disintegrated steel slag obtained by smashing waste slag discharged from a steel mill and performing magnetic separation according to a thermal disintegrating method, and has an apparent density not less than 3.2 g/cm³; the steel slag is divided into a coarse steel slag aggregate and a fine steel slag aggregate according to sieve pores of 4.75 mm, and the steel slag has grades of: 15 wt % to 18 wt % for a pore size of 19 mm to 26.5 mm, 20 wt % to 24 wt % for a pore size of 9.5 mm to 19 mm, 19 wt % to 21 wt % for a pore size of 4.75 mm to 9.5 mm, 13 wt % to 15 wt % for a pore size of 2.36 mm to 4.75 mm, and 23 wt % to 27 wt % for a pore size of 0 mm to 2.36 mm.

5. The whole-granulation steel slag pavement base course material for the heavy-load pavement according to claim 1, wherein immersion expansion ratios of the course steel slag aggregate and the fine steel slag aggregate do not exceed 2.0%.

6. The whole-granulation steel slag pavement base course material for the heavy-load pavement according to claim 1, wherein the content of f-CaO in the steel slag aggregate does not exceed 3.0 wt %.

7. The whole-granulation steel slag pavement base course material for the heavy-load pavement according to claim 1, wherein the water is ordinary drinking water.

8. The whole-granulation steel slag pavement base course material for the heavy-load pavement according to claim 1, wherein being prepared by a method through the following steps:
1) respectively selecting the binder and the steel slag aggregate according to the following requirements: the percentages in the total mass of the binder and the steel slag aggregate are as follows: the binder is 3.4% to 5.0%, and the steel slag aggregate is 95.0% to 96.6%, wherein the binder is prepared by mixing the cement with the steel slag micropowder according to a certain proportion, the mass percentages of the cement and the steel slag micropowder are as follows: the cement is 70% to 90%, and the steel slag micropowder is 10% to 30%; the steel slag aggregate has grades of: 15 wt % to 18 wt % for a pore size of 19 mm to 26.5 mm, 20 wt % to 24 wt % for a pore size of 9.5 mm to 19 mm, 19 wt % to 21 wt % for a pore size of 4.75 mm to 9.5 mm, 13 wt % to 15 wt % for a pore size of 2.36 mm to 4.75 mm, and 23 wt % to 27 wt % for a pore size of 0 mm to 2.36 mm;
2) placing the steel slag aggregate in an environment at 105° C.±5° C., and drying the aggregate for generally not shorter than 4 hour to 6 hour until a constant weight is achieved;
3) taking 5 parts of the dry materials according to a mass ratio, setting 5 groups of water contents in advance, with a difference of 0.5% to 1.5% in sequence, then adding water into the dry materials respectively to obtain a mixture, and stirring the mixture until the mixture is uniform, then performing heavy compaction, testing an actual water content and a maximum dry density, and finally drawing a dry density curve to obtain an optimal water content and a maximum dry density;
4) taking an appropriate amount of the dry materials according to a certain mass ratio, adding water required for immersion, then mixing the dry materials with the water to obtain a mixture, stirring the mixture for 5 minute to 10 minute until the mixture is uniform, and putting the uniformly mixed mixture into a closed container for immersion for 6 hour to 12 hour, wherein the content of the added water is 1% to 2% less than the optimal water content in the step 3;
5) adding an appropriate amount of water into the immersed mixture in the step 4 to reach the optimal water content, stirring the water and the mixture for 5 minute to 10 minute, then adding a uniformly mixed binder to obtain a mixture, and performing secondary stirring for 5 minute to 10 minute until the mixture is uniformly mixed; and
6) within 1 hour after adding the binder, uniformly filling a mold with a stirred mixture, controlling the density, and performing static press molding to obtain a base course material test sample.
